(19) United States
(12) Patent Application Publication
(10) Pub. No.: US 2009/0165303 A1
(43) Pub. Date: Jul. 2, 2009

(54) DUAL-ACTION HAIR TRIMMER

(76) Inventors: Patrick Burgess, Marina Vallarta (MX); Tylor Garland, Studio City, CA (US); Aldis Rauda, West Hollywood, CA (US); Stan Chudzik, Alpharetta, GA (US); Christin Hartsfield, Atlanta, GA (US)

Correspondence Address: GARDNER GROFF GREENWALD & VILLANUEVA, PC, 2018 POWERS FERRY ROAD, SUITE 800, ATLANTA, GA, 30339, US

(21) Appl. No.: 11/965,434

(22) Filed: Dec. 27, 2007

(51) Int. Cl. B26B 19/00; B26B 19/28; B26B 21/00

(52) U.S. Cl. 30/29.5; 30/34.1; 30/45; 30/50

(57) ABSTRACT

An electric hair-trimming device includes a body having two opposite ends, two trimming heads mounted to the two opposite ends of the body, and two endcaps that detachably couple to the two opposite ends of the body to cover the two trimming heads. The endcaps each have a generally flat end surface such that the device can be stood upright on either of the endcaps. In an example embodiment, the trimming heads are provided by a nose-hair trimmer and a detail trimmer. And in another example embodiment, the nose-hair trimmer includes a high surface-porosity foil shroud.

### CROSS-REFERENCE TO RELATED APPLICATION

This application claims the priority benefit of U.S. Design patent application Ser. No. 29/275,611, filed Dec. 30, 2006, the entire scope and content of which is hereby incorporated herein by reference.

### TECHNICAL FIELD

The present invention relates generally to devices for grooming hair and, in particular, to trimmers for facial and other body hair.

### BACKGROUND OF THE INVENTION

Men today tend to pay more attention to hair grooming, and consequently many men have a number of hair-grooming devices in their bathrooms. These hair-grooming devices include electric razors/shavers, beard and mustache trimmers, nose and ear hair trimmers, detail trimmers for the neckline, sideburns, and edges of beards and mustaches, and other corded and cordless hair-trimming tools. In addition, many men today have clean- or close-shaven heads and cut their hair at home with electric hair clippers. Furthermore, more and more men today shave additional body parts such as the chest, abs, shoulders, back, underarms, groin and legs with electric body shavers/trimmers specially adapted for these hair-grooming functions. These hair-grooming devices are all in addition to other hair-care products such as brushes, combs, and styling gels that men typically use. And this is does not include all the other bathroom vanity items that men and their spouses commonly use. The result is often frustration caused by an over-crowded bathroom vanity, which is particularly exacerbated by all of the hair-trimming devices.

Several manufacturers have tried to resolve this problem by using a docking station approach to reduce the footprint of the hair-trimming devices on the bathroom vanity. These products typically include a docking station that holds and charges an electric trimmer device and that also holds a number of trimmer heads that detachably install on the trimmer device. The trimmer heads have different functionalities for trimming hair from different areas of the body. However, these products have not proved entirely satisfactory.

Accordingly, it can be seen that a need exists for a better way to reduce the footprint of hair-trimming devices in the bathroom. It is to the provision of solutions meeting this and other needs that the present invention is primarily directed.

### SUMMARY OF THE INVENTION

Generally described, the present invention provides an electric hair-trimming device having a body with two opposite ends, two trimming heads mounted to the two opposite ends of the body, and two endcaps that detachably couple to the two opposite ends of the body to cover the two trimming heads. The body houses a power connector and a control system electrically connected to the power connector. The power connector is electrically connected to an internal or external power source such as batteries, 120/240 line voltage, etc. The control system includes one or more motors and two actuator switches electrically connected to the motor. Each of the trimming heads are mechanically driven by the motors when the corresponding switch is actuated. In this way, the hair-trimming device provides for two hair-trimming functions in a single device that takes up less counter space than two dedicated hair-trimming devices do.

In an example embodiment, the two trimming heads are provided by a nose-hair trimming head (for nose hair, ear hair, etc.) and a detail trimming head (for necklines, sideburns, eyebrows, etc.). In alternative embodiments, the two trimming heads are provided by a low-grow trimming head (for abs, chest, shoulders, back, etc.) and a no-grow trimming head (for cleanly shaving beard/mustache hair and head hair). And in other alternative embodiments other trimming functions are provided and/or more than two trimming functions are provided. In addition, both of the trimming heads may be driven by a single motor or the control system may include two motors with one for each trimming head.

Furthermore, the two endcaps each have a generally flat end surface that is preferably at least as large in surface area as a cross-section of the trimmer body. In this way, the hair-trimming device can be stood upright stably on either of the endcaps for storage when not in use. This further reduces the footprint of the device and further saves bathroom vanity counter-space.

In a second embodiment there is provided an improved nose-hair trimming head for use in the dual-action hair-trimming device of the first embodiment or in a single-action hair-trimming device. The nose-hair trimming head includes a blade assembly, a shroud, and a base that the blade assembly and the shroud are mounted to. The shroud is a perforated foil shroud with a high surface porosity of, for example, 50% or higher. In this way, the high surface-porosity foil shroud allows more nose hairs into the cutting zone through the sidewalls of the shroud and is therefore better able to trim more and finer nose hairs.

The specific techniques and structures employed by the invention to improve over the drawbacks of the prior devices and accomplish the advantages described herein will become apparent from the following detailed description of the example embodiments of the invention and the appended drawings and claims.

### BRIEF DESCRIPTION OF THE DRAWINGS

FIG. 1 is a left end perspective view of an electric hair-trimming device according to a first example embodiment of the present invention, showing a detail trimming head and a nose-hair trimming head on opposite ends of the device.

FIG. 2 is a bottom side view of the hair-trimming device of FIG. 1.

FIG. 3 is a top side view of the hair-trimming device of FIG. 1.

FIG. 4 is a front side view of the hair-trimming device of FIG. 1.

FIG. 5 is a rear side view of the hair-trimming device of FIG. 1.

FIG. 6 is a right end view of the hair-trimming device of FIG. 1.

FIG. 7 is a left end view of the hair-trimming device of FIG. 1.

FIG. 8 is a right end perspective view of the hair-trimming device of FIG. 1 with the housing shown transparently to reveal the interior components.

FIG. 9 is a bottom perspective view of the hair-trimming device of FIG. 1 with the back panel removed to show the battery compartment.

FIG. 10 is a top longitudinal cross-sectional view of the hair-trimming device of FIG. 1 showing the trimming heads detached and schematically showing the interior components.

FIG. 11 is a perspective view of the hair-trimming device of FIG. 1 showing endcaps covering the trimming heads.

FIG. 12 is a perspective view of the hair-trimming device of FIG. 11 showing the device standing upright on the detail trimmer endcap and showing the nose-hair trimmer endcap removed for use.

FIG. 13 is a perspective view of the hair-trimming device of FIG. 11 showing the device standing upright on the nose-hair trimmer endcap and showing the detail trimmer endcap removed for use.

FIG. 14 is a side cross-sectional view of a nose-hair trimming head of an electric hair-trimming device according to a second example embodiment.

FIG. 15 is a front side exploded view of the nose-hair trimming head of the electric hair-trimming device of FIG. 14 showing the blade assembly and the shroud.

FIG. 16 is a right side view of the blade assembly of FIG. 15.

FIG. 17 is a plan view of the blade assembly of FIG. 16.

### DETAILED DESCRIPTION OF EXAMPLE EMBODIMENTS

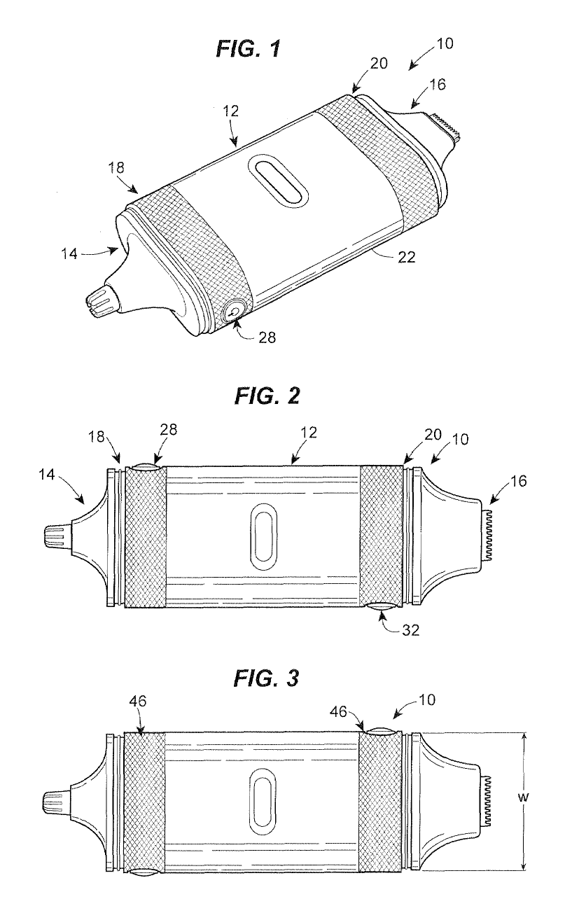

Referring now to the drawing figures, FIGS. 1-13 show an electric hair-trimming device 10 according to a first example embodiment of the present invention. The trimming device 10 includes a main body 12, a first trimming head 14, and a second trimming head 16. The body 12 a first end 18 and a second end 20 that is opposite from the first end. The first trimming head 14 is mounted to the first end 18 of the body 12, and the second trimming head 16 is mounted to the second end 20 of the body 12. In this way, multiple trimming functions are combined into a single trimming device, thereby talking up less counter space on the bathroom vanity and helping to alleviate the problem of overcrowded bathroom vanities.

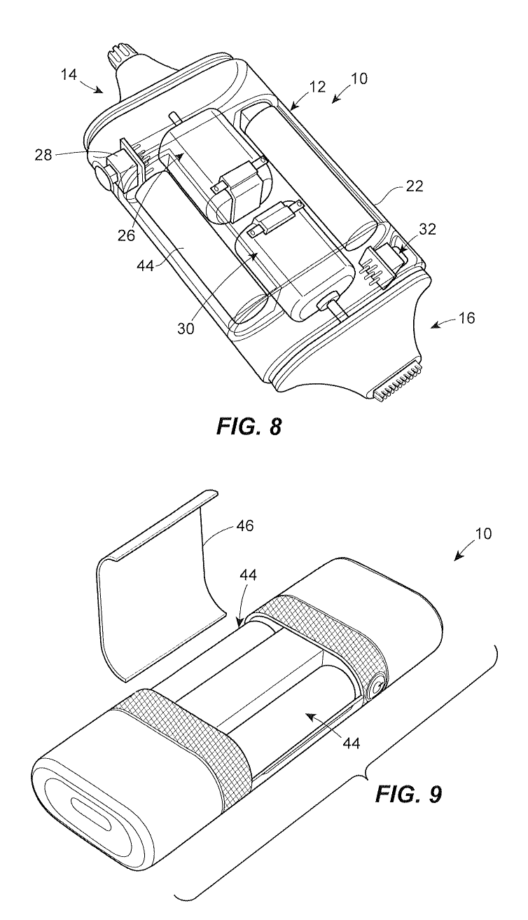

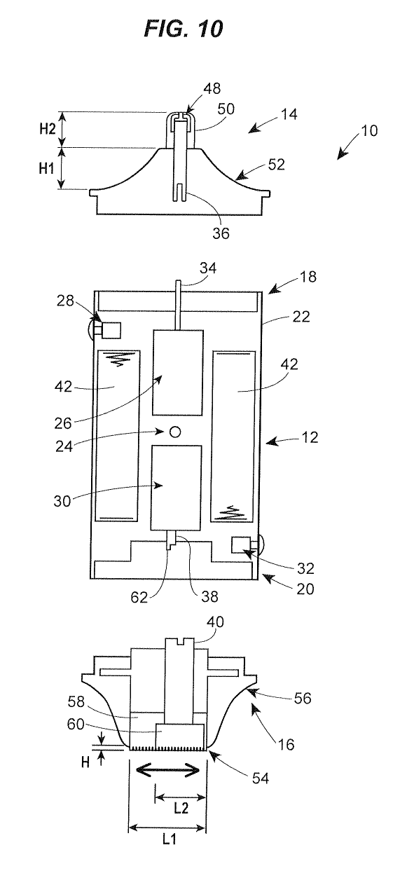

The main body 12 includes a housing 22 that houses a power source connector 24 and a control system. In the embodiment depicted in FIGS. 8 and 10, the control system includes a first motor 26, a first actuator switch 28, second motor 30, and a second actuator switch 32. The first actuator switch 28 is electrically connected between the power source connector 24 and the first motor 26. Similarly, the second actuator switch 32 is electrically connected between the power source connector 24 and the second motor 30. In addition, the first motor 26 has an output shaft 34 that is mechanically coupled to an input shaft 36 of the first trimming head 14. Similarly, the second motor 30 has an output shaft 38 that is mechanically coupled to an input member 40 of the second trimming head 16. The electrical connections can be made by conventional electrical wiring as is known in the art. For simplicity and clarity, the electrical connections between the various components are not shown in the drawing figures.

The motors 26 and 30 of the depicted embodiment are rotary motors with rotary output shafts 34 and 38, as are known in the art and commercially available from numerous vendors. In a typical commercial embodiment, the motors 26 and 30 produce about 9,300 RPM and a blade running speed of about 5,000 to 7,000 RPM, depending on the trimming head being driven. In addition, the actuator switches 28 and 32 of the depicted embodiment are push-button “on-off” switches, as are known in the art and commercially available from numerous vendors. In an alternative embodiment, the trimmer includes a single motor for driving both of the trimming heads. In this embodiment, there may be additionally provided a gear-train mechanically coupled between the single motor and the two trimming heads to adjust the RPMs to match the desired RPM input to the different trimming heads. Or the motor may be a two-speed motor with the two speeds selected to match the desired RPM input to the different trimming heads. In other alternative embodiments, other types of motors and switches are provided, as may be desired for specific trimming head functionality.

In the depicted embodiment, the trimming device 10 is powered by conventional “AAA” batteries. As shown in FIGS. 8-10, the body housing 22 has two battery compartments 42 that receive the batteries 44, and a removable back panel 46 that covers the battery compartments. The power source connector 24 is electrically connected to the batteries 44 by wiring or the like (not shown). In addition, the trimming device 10 may have a power indicator (e.g., with LCDs or LEDs) that signals the remaining life of the batteries or the time left before a recharge/new battery is needed.

In an alternative embodiment, the trimming device is designed for using other sizes of batteries (9-volt, “AA”, etc.). In another alternative embodiment, the trimming device includes an electric cord with a plug for plugging into wall receptacles, in addition to or instead of the battery power (e.g., an AC/DC device). In still other alternative embodiments, the trimming device includes rechargeable batteries (e.g., rechargeable NiCad batteries), a solar power device, a hydrogen cell power device, a gas powered device (e.g., butane), and/or other devices for powering portable electric devices. In embodiments including rechargeable batteries, the trimming device may further include a conventional recharging docking station that recharges the batteries when not in use and aesthetically stores the trimming device on the vanity countertop. And in yet another alternative embodiment, the trimming device includes two power sources (e.g., rechargeable or disposable batteries) with one of the power sources wired to one of the motors and with the other one of the power sources wired to the other one of the motors.

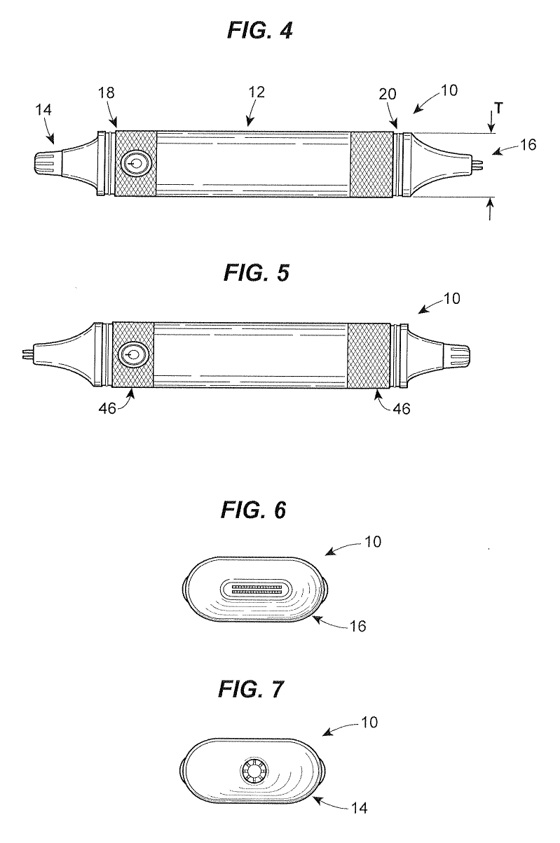

In addition, the body 12 of the trimming device 10 has ergonomic features that make it easier and more comfortable to use. In particular, the body 12 has two circumferential gripping sections 46 adjacent the body ends 18 and 20. The gripping sections 46 are each made of a soft material (e.g., soft plastic or rubber) with a textured surface that provides for better gripping and control of the trimming device 10. Furthermore, the shape of the body 12 is oblong and generally flat, with an aspect ratio of about 2 to 1. In the embodiment depicted in FIGS. 3-4, for example, the body 12 has a thickness “T” and a width “W” of about 25 mm and about 50 mm, respectively. This size and shape of the body 12 provides more surface area for improved gripping and control of the trimming device 10 when held for use by an adult male with average-sized hands.

The trimming heads 14 and 16 are preferably selected for hair-trimming functions that are commonly used by men with certain common hair-grooming needs. For example, in the depicted embodiment, the trimming heads 14 and 16 are provided by a nose-hair trimming head and a detail trimming head. The nose-hair trimming head 14 is typically used for trimming nose hair and ear hair. And the detail trimming head 16 is typically used for trimming necklines, sideburns, between eyebrows, beard/mustache edges, etc. These trimming functions are commonly used by a wide range of men because all men have nose and ear hair and all men (except bald men) have sideburns and a neckline. In an alternative embodiment, the trimming heads are provided by a foil shaving head (a no-grow trimmer for cleanly shaving the beard and/or head) and a low-grow body hair trimming head (for the neck, chest, abdomen, back, groin, etc.). In other alternative embodiments, a dual-action personal grooming device may additionally or alternatively include non-hair-trimming heads. For example, a dual-action personal grooming device for women may include flat-iron and curling-iron attachment heads, hair dryer and flat- or curling-iron attachment heads, etc. In any case, the result is that consumers are provided with dual-action devices that reduce the number of hair-trimming appliances on the bathroom vanity, thereby alleviating the problem of overcrowded bathroom vanity counters.

Details of the nose-hair trimming head 14 and the detail trimming head 16 of the depicted embodiment will now be provided. These trimming heads 14 and 16 are similar to conventional trimming heads designed for the same functionality. It will be understood that the nose-hair trimming head 14 and the detail trimming head 16 can be provided with designs other than those specifically described herein, which other designs are well known in the art and therefore not expressly included herein.

As shown in FIG. 10, the nose-hair trimming head 14 includes a blade assembly 48, a shroud 50 covering the blade assembly, and a base 52 that mounts to the first end 18 of the body 12. The blade assembly 48 and the shroud 50 are mounted to and extend outwardly from the base 52. The blade assembly 48 includes two L-shaped blades that are attached to and rotationally driven by the rotary input shaft 36, which in turn is detachably coupled to the rotary output shaft 34 of the first motor 26. The shroud 50 has slots that receive the hairs, and the rotating blades shear off the hairs extending into the shroud.

In addition, the nose-hair trimming head 14 is unique in that the base 52 has an oblong shape to conform to the first end 18 of the body 12 and a height “H” of about 12.5 mm to about 13 mm, and the shroud 52 has a height “H2” extending from the base of about 9.5 mm to about 10 mm. This configuration provides improved cutting performance of the nose-hair trimming head 14.

The detail trimming head 16 includes a blade assembly 54 and a base 56 that mounts to the second end 18 of the body 12. The blade assembly 54 includes a stationary blade 58 and a blade 60 that moves, for example that translates in a reciprocating manner, relative to the stationary blade (as indicated by the double-headed directional arrow of FIG. 10). The stationary blade 58 is mounted to and extends outwardly from the base 56. And the moving blade 60 is movably mounted (e.g., by a tension spring element to the stationary blade 58 or to the base 56 to allow free movement in a plane perpendicular to the output shaft) and extends outwardly from the base. The moving blade 60 is attached to and translationally driven by the input member 40, which in turn is detachably coupled to the rotary output shaft 38 of the second motor 30. The rotary output shaft 38 has an eccentric drive member 62 that engages with the input member 40 to convert the rotary output motion to the translating motion. The stationary blade 58 and the moving blade 60 are serrated such that the serration notches in the stationary blade receive the hairs and the moving blade shears them off.

In addition, the detail trimming head 16 is unique in that the base 56 has an oblong shape to conform to the first end 18 of the body 12, the stationary blade 58 has a length “L1” of about 20 mm, the moving blade 60 has a length “L2” of about 16 mm, and the stationary and moving blades each have a height “H” extending from the base 58 of about 2 mm. This configuration provides improved cutting performance of the detail trimming head 16.

The trimming heads 14 and 16 are preferably detachably mounted to the body 12 so that they can be removed for cleaning. In the depicted embodiment, for example, the trimming heads 14 and 16 and the body 12 fit together with a snap-fit. In addition, the trimming device may be provided with more than two trimming heads. For example, in one alternative embodiment the trimming device includes the same two-ended body housing two motors, but includes three or more trimming heads with at least two of the trimming heads interchangeably mountable to a same one of the body ends. In another alternative embodiment, the trimming device includes three, four, or more trimming heads that mount to the body at three, four, or more locations (e.g., in a “T” or “X” configuration) and three, four, or more motors housed in the body and operably coupled to the trimming heads. And in still another alternative embodiment, the trimming device includes two, three, or more trimming heads that are fixedly mounted to the body and cannot be readily removed by the user.

The trimming heads 14 and 16 may optionally have a number of other features, as may be desired. In some embodiments, the trimming heads include a light (e.g., an LED) to illuminate body areas to be trimmed for better visibility when grooming. In other embodiments, the trimming heads include a vacuum system that suctions up the cut hair trimmings into a compartment that can be emptied after use. In still other embodiments, the trimming heads include a “juice-on-board” feature, for example, a container and a dispenser that apply conditioners, additives, or other skin-treating agents to the skin after hair cutting. In still other embodiments, the trimming devices include a display with a digital readout indicating the remaining time left before the blades need to be lubricated or replaced.

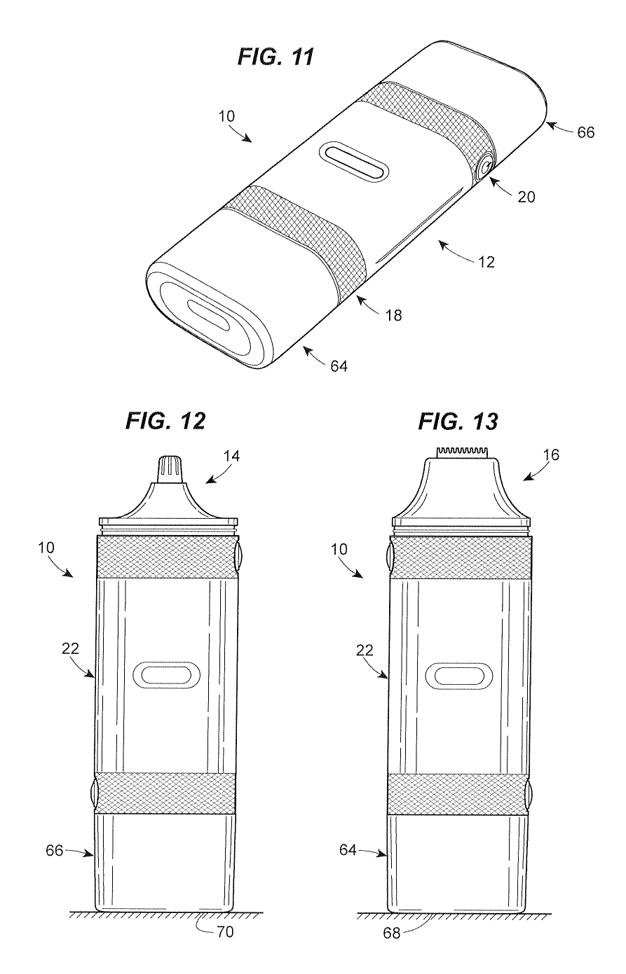

Referring to FIGS. 11-13, the trimming device 10 includes a first endcap 64 that detachably couples to the first end 18 of the body 12 to cover the first trimming head 14, and a second endcap 66 that detachably couples to the second end 20 of the body 12 to cover the second trimming head 16. The endcaps 64 and 66 detachably couple to the body 12 by, for example, a snap-fit connection. The endcaps 64 and 66 each have an end surface 68 and 70, respectively, that is generally flat and that has a surface area that is at least as large as the cross-sectional area of the body 12. In this way, when the first endcap 64 is mounted to the body 12 to cover the first trimming head 14, the trimming device 10 can be stood upright on the generally flat end surface 68 of the first endcap (see FIG. 13). And when the second endcap 66 is mounted to the body 12 to cover the second trimming head 16, the trimming device 10 can be stood upright on the generally flat end surface 70 of the second endcap (see FIG. 12). With this unique design, the dual-function trimming device 10 can be easily stored in a stable upright orientation on the bathroom vanity counter, thereby reducing the counter space needed for devices for the two trimming functions.

The trimming device 10 can be made using materials and fabrication techniques known to persons of ordinary skill in the art such as injection-molded acrylonitrile butadiene styrene (ABS) resin, polyoxymethylene (POM), nylon, thermoplastic elastomer (TPE) resin, etc. In a typical commercial embodiment, for example, the body housing 22, the trimming head bases 52 and 56, and the endcaps 64 and 66 are made of ABS resin. The body housing 22 and the trimming head bases 52 and 56 may be painted to match a metallic black color swatch, and the endcaps 64 and 66 may be made of a translucent resin so that the covered trimming heads 14 and 16 can be seen through them. And TPE resin 0-rings or the like may be provided (e.g., extending from and unitary with the gripping sections 46) at the interface between the trimmer body 12 and the trimming heads 14 and 16 for the snap-fit connection. The drive-train components (e.g., the output shafts 34 and 38 and the input drive members 36 and 40) that connect the motors 26 and 30 to the blade assemblies 48 and 54 are made of POM or nylon. The non-conductive components of the “on/off” actuator switches 28 and 32 and the gripping sections 46 are made of TPE resin. The push-button cover of the “ON/OFF” actuator switches 28 and 32 and the gripping sections 46 may have a molded-in repeating-diamond texture or another texture for enhanced gripping. And the shroud 50 and blades 48, 58, and 60 are made of stainless steel 420 for maintaining a sharp cutting blade and resisting corrosion.

In alternative embodiments, other materials and fabrication techniques are used. For example, the body housing and the trimming head bases may be made of higher-end materials such as polycarbonate or stainless steel. In addition, the blades can be made of ceramic materials such as zirconia ceramic (ZrO2) provided by Specialty Blades, Inc. Hot isostatic pressed (HIP) zirconia ceramic blades are extremely hard (approximately a Rockwell 75 rating), sharp, and wear-resistant. Furthermore, the detail blade assembly can include an EVA noise and vibration dampener placed on the moving blade, the nose-hair blade assembly can include an EVA noise and vibration dampener within the shroud. The EVA material can effectively drop the sound decibel range to about 70-75 dB, which is a more acceptable decibel level.

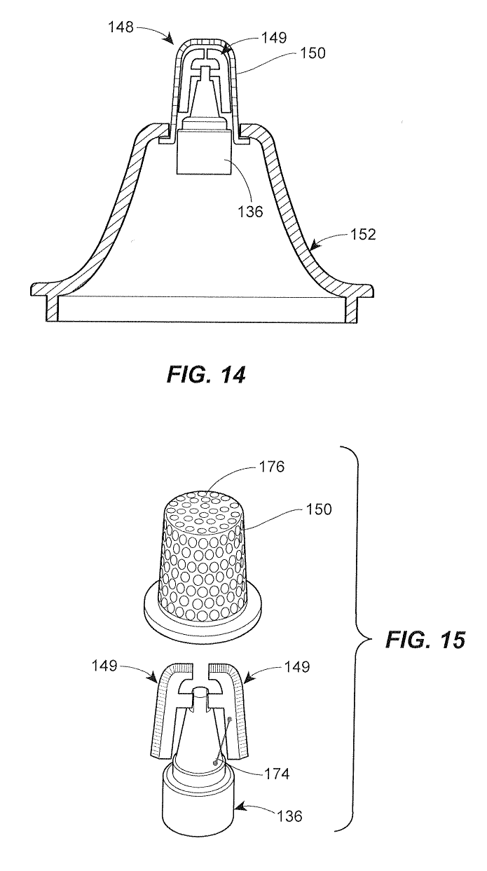

Turning now to FIGS. 14-17, there is shown a nose-hair trimming head 114 of a hair-trimming device according to a second example embodiment. The nose-hair trimming head 114 can be incorporated into the dual-action hair-trimming device 10 described above or it can be incorporated into a single-action hair-trimming device having drive and control components for only one trimming head. In any case, the nose-hair trimming head 114 is used with a hair-trimming device having a motor, an actuator switch, a power connector, etc.

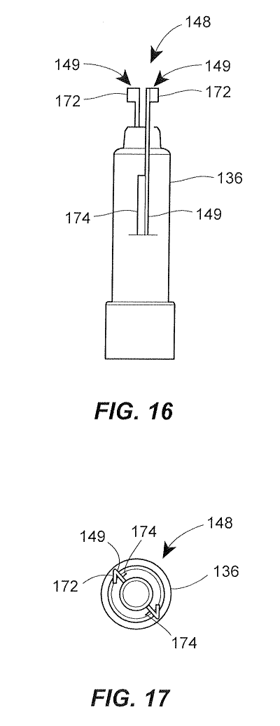

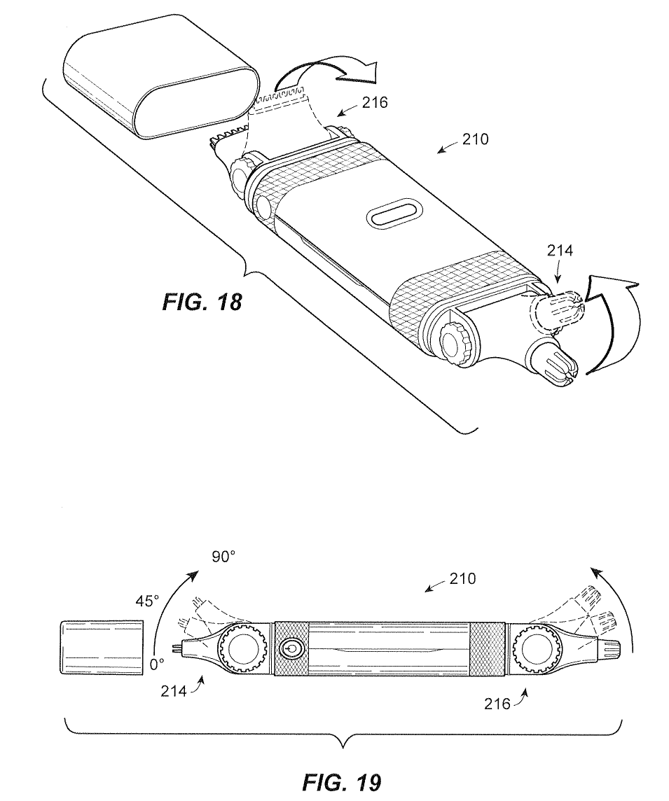

The nose-hair trimming head 114 includes a blade assembly 148, a shroud 150 covering the blade assembly, and a base 152. The blade assembly 148 and the shroud 150 are mounted to and extend from the base 152. And the base 152 detachably mounts to a main body of the trimming device. The blade assembly 148 preferably includes two generally L-shaped blades 149 that are attached to and extend from a center rotary input shaft 1 36 that couples to and is driven by a rotary output shaft of the motor. The L-shaped blades 149 are inverted and face each other to generally form the shape of an inverted “U,” as depicted. In addition, the blade extensions 172 (the horizontal leg of the “L”) at the top ends of the blades 149 are angled inwardly (see FIGS. 16 and 17). The result is that there are long cutting edges (along the vertical outer edges and the horizontal upper edges) for cutting hairs. In addition, spring elements, for example the leaf springs 174 depicted, extend from the input shaft 136 and engage the blades 149 to bias them into close proximity to the shroud 150 to ensure a “scissor-like” cutting action when a hair shaft is inserted into the perforations of the shroud.

Furthermore, the shroud 150 is foil shroud with a plurality of perforations 176. In a typical commercial embodiment, the foil shroud 150 is stamped of perforated stainless steel of the type used for the metal foil on facial shavers. Preferably, the foil shroud has a high surface porosity (i.e., it has a high percentage of void surface area relative to conventional shaver foils). In one embodiment the shroud 150 has a surface porosity of 50% or higher, and in another embodiment the shroud 150 has a surface porosity of between about 60% and 70%. In this way, the high surface-porosity foil shroud 150 allows more nose hairs into the cutting zone through the sidewalls of the shroud, so it cuts more and finer nose hairs. In alternative embodiments, the foil shroud is made of other materials by other fabrication techniques.

It is to be understood that this invention is not limited to the specific devices, methods, conditions, or parameters described and/or shown herein, and that the terminology used herein is for the purpose of describing particular embodiments by way of example only. Thus, the terminology is intended to be broadly construed and is not intended to be limiting of the claimed invention. For example, as used in the specification including the appended claims, the singular forms “a,” “an,” and “the” include the plural, the term “or” means “and/or,” and reference to a particular numerical value includes at least that particular value, unless the context clearly dictates otherwise. In addition, any methods described herein are not intended to be limited to the sequence of steps described but can be carried out in other sequences, unless expressly stated otherwise herein.

While the invention has been shown and described in example forms, it will be apparent to those skilled in the art that many modifications, additions, and deletions can be made therein without departing from the spirit and scope of the invention as defined by the following claims.

What is claimed is:

1. An electric hair-trimming device, comprising:
a body having a first end and a second end opposite the first end, wherein the body houses a power source connector and a control system operably connected to the power source connector;
a first trimming head mounted to the first end of the body and operably connected to the control system; and
a second trimming head mounted to the second end of the body and operably connected to the control system.

2. The hair-trimming device of claim 1, wherein the first trimming head is a nose-hair trimming head.

3. The hair-trimming device of claim 2, wherein the second trimming head is a detail trimming head.

4. The hair-trimming device of claim 1, wherein the second trimming head is a detail trimming head.

5. The hair-trimming device of claim 1, wherein the control system includes a first motor and a second motor, wherein the first motor is operably coupled to the first trimming head and the second motor is operably coupled to the second trimming head.

6. The hair-trimming device of claim 5, wherein the control system includes a first actuator switch and a second actuator switch, wherein the first actuator switch is electrically connected to the first motor to control the first trimming head, and the second actuator switch is electrically connected to the second motor to control the second trimming head.

7. The hair-trimming device of claim 1, further comprising a first endcap and a second endcap, wherein the first endcap detachably couples to the first end of the body to cover the first trimming head, and the second endcap detachably couples to the second end of the body to cover the second trimming head.

8. The hair-trimming device of claim 7, wherein the first endcap has a generally flat end surface, wherein when the first endcap is mounted to the body to cover the first trimming head, the device can be stood upright on the generally flat end surface of the first endcap.

9. The hair-trimming device of claim 8, wherein the second endcap has a generally flat end surface, wherein when the second endcap is mounted to the body to cover the second trimming head, the device can be stood upright on the generally flat end surface of the second endcap.

10. An electric hair-trimming device, comprising:
a body having a first end and a second end opposite the first end, wherein the body houses a power source connector and a control system electrically connected to the power source connector, wherein the control system includes a first actuator switch, a second actuator switch, and at least one motor electrically connected to the first actuator switch and the second actuator switch;
a first trimming head mounted to the first end of the body and operably connected to the first actuator switch and the at least one motor;
a second trimming head mounted to the second end of the body and operably connected to the second actuator switch and the at least one motor;
a first endcap that detachably couples to the first end of the body to cover the first trimming head, wherein the first endcap has a generally flat end surface and, when the first endcap is mounted to the body to cover the first trimming head, the device can be stood upright on the generally flat end surface of the first endcap; and
a second endcap that detachably couples to the second end of the body to cover the second trimming head, wherein the second endcap has a generally flat end surface and, when the second endcap is mounted to the body to cover the second trimming head, the device can be stood upright on the generally flat end surface of the second endcap.

11. The hair-trimming device of claim 10, wherein the at least one motor comprises a first motor electrically connected to the first actuator switch and a second motor electrically connected to the second actuator switch.

12. The hair-trimming device of claim 10, wherein the first trimming head is a nose-hair trimming head.

13. The hair-trimming device of claim 12, wherein the nose-hair trimming head includes a blade assembly and a shroud covering the blade assembly, wherein the shroud is a foil shroud.

14. The hair-trimming device of claim 12, wherein the nose-hair trimming head includes a blade assembly, a shroud covering the blade assembly, and a base that mounts to the body and from which the blade assembly and the shroud extend, wherein the base has a height of about 12.5 mm to about 13 mm and the shroud has a height extending from the base of about 9.5 mm to about 10 mm.

15. The hair-trimming device of claim 10, wherein the second trimming head is a detail trimming head.

16. The hair-trimming device of claim 15, wherein the detail trimming head includes a blade assembly with a stationary blade and a moving blade, wherein the stationary blade has a length of about 20 mm and a height of about 2 mm, and the moving blade has a length of about 16 mm and a height of about 2 mm.

17. The hair-trimming device of claim 10, wherein the body is oblong and generally flat with an aspect ratio of about 2 to 1.

18. The hair-trimming device of claim 10, wherein the first and second trimming heads are detachably mounted to the body so that they can be removed for cleaning.

19. The hair-trimming device of claim 10, further comprising at least one battery housed in the body and electrially connected to the power source connector.

20. An electric hair-trimming device, comprising:
a body housing a power source connector, a first actuator switch electrically connected to the power source connector, and a motor electrically connected to the first actuator switch;
a nose-hair trimming head mounted to the first end of the body and operably coupled to the motor, wherein the nose-hair trimming head includes a blade assembly, a shroud covering the blade assembly, and a base from which the blade assembly and the shroud extend, wherein the blade assembly includes two generally L-shaped blades, the shroud is a high surface-porosity foil shroud with a surface porosity of 50% or higher, the base has a height of about 12.5 mm to about 13 mm, and the shroud has a height extending from the base of about 9.5 mm to about 10 mm.
